(19) United States
(12) Patent Application Publication
(10) Pub. No.: US 2023/0201973 A1
(43) Pub. Date: Jun. 29, 2023

(54) SYSTEM AND METHOD FOR AUTOMATIC DETECTION OF WELDING TASKS

(71) Applicant: INROTECH A/S, Odense SØ (DK)

(72) Inventors: Flemming Jørgensen, Odense SV (DK); Rasmus Faudel, Odense M (DK); Thiusius Rajeeth Savarimuthu, Odense SV (DK); Anders Glent Buch, Odense NØ (DK); Oliver Klinggaard, Odense V (DK); Lasse Nøjgaard, Odense C (DK)

(21) Appl. No.: 17/926,810

(22) PCT Filed: May 25, 2021
(86) PCT No.: PCT/EP2021/063889

§ 371 Date: Nov. 21, 2022

(30) Foreign Application Priority Data
May 25, 2020 (EP) 20176332.3

(51) Int. Cl. B23K 31/02; B23K 26/03

(52) U.S. Cl. CPC B23K 31/02; B23K 26/032

(57) ABSTRACT

A system and a method is for automating welding processes, in particular welding processes in the heavy industries. One embodiment regards a computer implemented method for automatic detection and/or planning of a welding task in a welding environment, the method including the steps of: obtaining scanning data from a scan of the welding environment, detecting welding object(s) in the scanning data by means of artificial intelligence employing a machine learning algorithm, wherein the machine learning algorithm has been trained on real and simulated 3D data of known welding objects, determining the pose of each detected welding object, and optionally generating a welding path for each detected welding object.

### CROSS-REFERENCE TO RELATED APPLICATIONS

This application is the U.S. National Stage of PCT/EP2021/063889 filed on May 25, 2021, which claims priority to European Patent Application 20176332.3 filed on May 25, 2020, the entire content of both are incorporated herein by reference in their entirety.

### FIELD OF THE INVENTION

The present invention relates to a system and a method for automating welding processes, in particular welding processes in the heavy industries.

### BACKGROUND OF THE INVENTION

In the manufacturing industry, robots are used to perform accurate, highly precise operations every day. Many of these industrial robots are programmed to perform the same exact motions and to repeat these many times a day. Accordingly, robotic welding systems are commonly used to accurately and repeatedly weld components together in industries like the automotive industry as well as in heavy industry, such as in shipyards. Whereas welding applications in the automotive industries is dominated by pre-programmed welding programs, the welding processes in the heavy industries are dominated by tasks that differ between each run as the welding operations are complex with huge tolerances of the components. This means that sensing and detection of the welding task online is an essential requirement of the automation of the process.

One of the challenges in robotic welding applications is to find out where the welding process is to happen and what the welding path for a particular welding task is. The optimal welding path depends on the type of objects and features present in a welding task, objects such as profiles, bars, stiffeners, brackets, collar plates, inserts, cutouts, waterholes, welding seams, plate connections, chamfers, tacks, gaps, plate thickness, bevel, scallop, etc.

CN110227876 and CN 110524581 discloses methods for autonomously planning a robot welding path based scanning of a known welding object to obtain on 3D point cloud data and compare to a 3D point cloud data of a CAD model of the known welding object in order to obtain the complete work piece weld information, extract the weld pose information and process it to plan the robot welding path.

### SUMMARY OF THE INVENTION

Often the welding objects of present and subsequent welding tasks are not known. The purpose of the present disclosure is therefore to be able to plan the robot welding path for robotic welding in a complex welding environment, such as in the heavy industries.

The present disclosure therefore relates to a method for automatic detection of a welding task in a welding environment. Once the welding task has been determined it is possible to plan and generate a welding path of the welding objects in the welding environment, which can be executed by a welding robot. Generally speaking the presently disclosed system and method relates to automatic detection of a welding task in a welding environment by obtaining scanning data of the welding environment and using artificial intelligence (AI), such as deep learning and/or neural networks, to detect and identify/recognize welding objects in the welding environment. This relies on the fact that even though the specific objects to be welded in present and subsequent welding tasks are not known, the group of possible welding objects are known. I.e. once scanning data of the welding environment has been obtained, it will be a matter of recognizing the welding objects in the welding environment. But that is not a simple task and utilization of AI is one way to achieve that.

One embodiment of the present disclosure therefore relates to a computer implemented method for automatic detection and/or planning of a welding task in a welding environment, the method comprising the steps of:

obtaining scanning data from a scan of the welding environment,

detecting welding object(s) in the scanning data, and identifying the type of the welding object(s) by means of artificial intelligence, such as machine learning, wherein the machine learning algorithm has been trained on real and simulated 3D data of known welding objects,

determining the pose of each detected welding object, and

optionally generating a welding path for each detected welding object.

Another embodiment of the present disclosure relates to a computer implemented method for automatic detection and/or planning of a welding task in a welding environment, the method comprising the steps of:

obtaining scanning data from a 3D scan of the welding environment,

detecting welding object(s) in the scanning data by means of artificial intelligence employing a supervised learning algorithm, wherein the supervised learning algorithm has been trained on real and simulated 3D data of known welding objects,

determining the pose of each detected welding object, and

optionally generating a welding path for each detected welding object.

Once welding objects are detected in the scanning data by means of AI it is possible to plan an associated welding task because the welding objects are now known. Planning of a welding task typically includes generating a welding path for each detected welding object. It is also preferred to determine the pose of each detected welding object once a welding object is detected. The presently disclosed method can thereby automatically detect and/or identify the types of objects within the weld environment in order to determine which components and along which path the welding process should be executed.

A key aspect of the present invention is that the AI algorithm, e.g. a machine learning algorithm, supervised or unsupervised, has been trained on 3D data of known welding objects, real 3D data and/or simulated 3D data, preferably real and simulated 3D data of known welding objects and real and simulated data of the background, e.g. the welding environment. Generally, it would be very time consuming to train a machine learning algorithm using only real 3D data e.g. obtained from a 3D scan of known welding objects. The inventors have realised that by combining real 3D data with simulated 3D data (e.g. point clouds generated from CAD models of known welding objects), much more training material can be provided in a shorter period. It is even possible to detect welding objects in the welding environment based merely on 2D data, e.g. 2D images obtained from 2D scanning of the welding environment, which has been provided as input to the machine learning algorithm. However, it is preferred to use 3D data as input to the machine learning algorithm.

### BRIEF DESCRIPTION OF THE DRAWINGS

The invention will in the following be described in greater detail with reference to the accompanying drawings:

FIG. 1 shows a schematic overview of the system;

FIG. 2 shows three examples of simulated training data;

FIG. 3 shows three examples of real training data;

FIG. 4 shows the flow of the processing;

FIG. 5 shows a 2D sketch of a welding object, here a test panel;

FIG. 6 shows a 3D scan of a first part of the welding object shown in FIG. 5;

FIG. 7 shows a 3D scan of a second part of the welding object shown in FIG. 5;

FIG. 8 shows a 3D scan of a third part of the welding object shown in FIG. 5; and

FIG. 9 shows a 3D scan of a fourth part of the welding object shown in FIG. 5.

### DETAILED DESCRIPTION OF THE INVENTION

The term “welding environment” refers herein to the area of which the welding task is to happen, hence the area in which all objects of a welding task are placed. A welding task may comprise one or more welding objects and hence one or more welding objects may be placed in the welding environment.

Welding objects refer to the objects of a given welding task. Thus, not all welding objects should necessarily be welded, as some welding objects/objects of a welding task may be drain holes or other objects to avoid in the welding process. Their detection and pose is still important when determining the welding path as they may also indicate areas to avoid in the welding path.

Artificial intelligence can be employed to identify a specific context or action, or generate a probability distribution of specific states of a system without human intervention. Artificial intelligence relies on applying advanced mathematical algorithms, e.g. decision trees, neural networks, regression analysis, cluster analysis, genetic algorithms, and reinforced learning, to a set of available data (information) on the system. The artificial intelligence techniques can be used to perform determinations disclosed herein.

Artificial neural networks (ANN) or just “neural network” as used herein, or connectionist systems are computing systems inspired by the biological neural networks that constitute animal brains. Such systems learn (progressively improve their ability) to do tasks by considering examples, generally without task-specific programming. For example, in image recognition, they might learn to identify images that contain cats by analyzing example images that have been manually labeled as “cat” or “no cat” and using the analytic results to identify cats in other images. They have found most use in applications difficult to express with a traditional computer algorithm using rule-based programming. An ANN is based on a collection of connected units called artificial neurons, i.e. modelling the neurons in a brain. Like the synapses in a biological brain each connection can transmit a signal to other neurons. An artificial neuron that receives a signal then processes it and can signal neurons connected to it.

Deep learning (also known as deep structured learning or differential programming) is part of a broader family of machine learning methods based on artificial neural networks with representation learning. Learning can be supervised, semi-supervised or unsupervised. Deep learning architectures such as deep neural networks, deep belief networks, recurrent neural networks and convolutional neural networks have been applied to fields including computer vision, as also used herein.

A deep neural network is an artificial neural network with multiple layers between the input and output layers. A deep neural network finds the correct mathematical manipulation to relate the input into the output, whether it be a linear relationship or a non-linear relationship. The network moves through the layers calculating the probability of each output.

The presently disclosed approach may be based on a neural network or a deep neural network. Both terms are used interchangeably in the present disclosure. As used herein, the term “neural network” refers to an interconnected group of natural or artificial neurons that uses a computational/mathematical model for information processing based on a connectionistic approach to computation. Neural networks are adaptive systems that change structure based on external or internal information that flows through the network. They are used to implement non-linear statistical data modelling and may be used to model complex relationships between inputs and outputs. In this case the input can be point cloud data and the output can be detection of welding objects in the input point cloud data.

As used herein, the term “point cloud” generally refers to a three-dimensional set of points forming a three-dimensional view of a subject reconstructed from a number of two-dimensional views. In a three-dimensional image capture system, a number of such point clouds may also be registered and combined into an aggregate point cloud constructed from images captured by a moving camera, e.g. a scanner. In this approach point clouds can be generated from CAD data, e.g. CAD data of known welding objects and thereby be used to generate and represent simulated data. But point clouds can also be generated from real 3D scan data, of e.g. welding objects, background data, welding environments, etc., and thereby represent real data.

In computer vision, image segmentation is the process of partitioning a digital image into multiple segments in order to simplify and/or change the representation of an image into something that is more meaningful and easier to analyse, aka image segmentation is the process of assigning a label to every pixel in an image such that pixels with the same label share certain characteristics. Semantic segmentation then refers to the process of linking each pixel in an image to a class label, i.e. semantic image segmentation is the task of classifying each pixel in an image from a predefined set of classes.

Computing the pose (aka 3D pose) of a rigid body with respect to a camera is a well-studied problem in computer/robot vision. A 3D pose can be solved by starting with the known features of an object and matching these features with their 2D correspondence in the image. Features such as point and line segments are commonly used. In computer vision “pose estimation” may be the determination of the 3D pose of a rigid body from a single 2D image. If using point-based correspondences, the problem is known as “perspective-n-point,” where n is the number of correspondences. Three non-collinear points provides four solutions. Four or more non-collinear points provides a unique solution. Alternatively pose estimation may be provided by means of data acquired from a time-of-flight camera.

In one embodiment of the present disclosure at least one scanner is used to acquire and generate scanning data of the welding environment in order to detect the objects to be welded. The scanner may be a 1D scanner, e.g. a line scanner, a 2D scanner, e.g. a standard camera, or a 3D scanner. The scanner may be part of the presently disclosed welding system. The scan data may be processed prior to it being used as input data to the AI algorithm, e.g. deep learning algorithm, used to detect and recognise shapes and/or objects and/or parts of objects which should be welded. The data from the scanner can be in form of frame data, which can be used to form 2D data to input to the supervised learning algorithm. But frame data can also be used to generate a 3D point cloud which can be used as input to the AI algorithm, e.g. a supervised learning algorithm. However, 3D point cloud data can also be directly outputted from the scanner. But the scan data will typically be unordered, e.g. an unordered 3D point cloud.

The object detection may be provided by using an AI/machine learning based tool, such as an AI/machine learning based algorithm, e.g. neural network or a deep neural network, to detect the welding objects, e.g. identify and determine the type of objects within the welding environment. An AI based approach typically relies on a trained model, and a trained model in the presently disclosed approach can preferably be trained on both real and simulated data to enable identification of welding objects such as profiles, bars, stiffeners, brackets, collar plates, inserts, cutouts, waterholes, welding seams, plate connections, chamfers, tacks, gaps, plate thickness, bevel, scallop, etc. Hence the AI based approach, e.g. neural network and/or deep learning, may learn the shapes of these objects through the training phase creating a representation of the distinguished features of the welding object, e.g. within the neural network. This representation may then be used in the detection phase to detect and identify the object, the location of the object and/or the pose of the object in the scan data. This information can then be used to plan the welding task.

As also stated above the learning/training of the model used can be supervised, semi-supervised or unsupervised. The most practical implementation is to use supervised learning because it is less time and resource consuming and it requires less data to supervise the model during training. In supervised learning subsidiary goals/teaching are introduced in several parts of the welding process, also during the detection and identification phase. However, in this case it has been realized that the combination of real data and simulated data can greatly increase the amount of relevant training data and therefore it has been shown to be possible to use unsupervised learning in the presently disclosed approach, where the model for example is trained by merely feeding an end goal into the training phase. E.g. an end goal can merely be a “good weld” and during the training a plurality of random variations is fed into the model thereby examining when a “good weld” is obtained. During such unsupervised learning the machine learning model's ability to detect and identify welding objects will also improve because a good weld cannot be obtained if the welding object is not detected and identified correctly. And in that regard the presently disclosed approach of combining real and simulated data in the training of the AI model has turned out to be a key factor.

The ratio between real data and simulated data has an influence on the performance of the presently disclosed automatic welding process. A success ratio of around 90% in automatic detection and identification of the welding objects can be acceptable in some setups and such a success ratio of around 90% can be obtained with a ratio of approx. 10% real data and 90% simulated data. Success ratios of more than 90%, e.g. 95% or close to 100% success ratio, requires more real data as input to the training phase. However, is has been shown that with a ratio of approx. 30% real data and 70% simulated data close to 100% success ratio can be obtained in welding object detection and identification. I.e. the robustness of the presently disclosed approach may scale with the ratio of real data and simulated data in the training.

The amount of data required as input to the training phase scales with the number of different welding objects that must be discriminated and identified. If only a few welding objects, e.g. less than 5 or 10 different welding objects, can be identified the amount of necessary real training data is limited to only a few real scans. However, if more than 10, or 50 or 100 or even thousands of welding objects must be discriminated during the automatic welding process, the amount of data going into the training also increases. I.e. the robustness of the presently disclosed approach may also scale with the number of welding objects that can be identified.

In a real setup the requirement regarding robustness of the identification and the number of possible welding objects are typically known, and then it will be a matter of collecting the suitable amount of real data and generating a suitable amount of simulated data for the training, to meet the robustness requirement.

Thus, it is possible to identify location and pose of each object of a welding task by applying an AI algorithm trained to recognise the individual welding objects in the point cloud data. This information may then be used to plan the welding task.

In the preferred embodiment of the present disclosure the object detection is used to identify the type/category of welding object such as profiles, bars, stiffeners, brackets, collar plates, inserts, cutouts, waterholes, welding seams, plate connections, chamfers, tacks, gaps, plate thickness, bevel, scallop, etc. Each of these exemplary categories of welding objects can have different types. Depending on the type of objects detected in a given welding task the method may determine the most suitable welding path such that some areas, such as waterholes, are avoided and the proper section of for example a bracket is welded.

Frame data from a scan of the welding environment can be used to generate a stitched scene-data from the individual frames. Advantageously the data points of the stitched scene-data from the individual frames are down-sampled or compressed prior to the generation of an organised 3D point cloud. In the preferred embodiment the outlying data points of the stitched scene-data from the individual frames are removed prior to the generation of the organised point cloud, such as by the use of random sample consensus. This may reduce or even prevents the use of computer power used to identify the nature of false-read outlier points.

In one embodiment the points of the 3D point cloud are segmented prior to object detection.

In the preferred embodiment of the present disclosure the AI approach is configured to recognise shapes and/or objects and/or part of objects to be welded in a given welding task. By object recognition it is possibly to identify the objects which should be welded and from the pose and position of the detected objects it is possible to determine the proper welding path. Some objects are to be avoided all together and other object has designated areas in which the welding should happen, and hence determination of the welding path may be straightforward once welding objects are detected by the presently disclosed method.

The learning/training phase may be provided exclusively on simulated data or exclusively on real data, i.e. scan data acquired from real physical objects. However, the best detection is provided with if the learning/training phase is based on combination of real data and simulated data, because the amount of training data can be greatly increased when using simulated data because such kind of simulated data can be automatically multiplied, whereas real data is usually necessary to improve the robustness of the object detection. The amount of real data is preferably between 5-50%, more preferably 10-40%, most preferably 10-30%, where the rest is simulated data. Simulated data can be point clouds generated from CAD models of the known welding objects, or virtual backgrounds or virtual welding environments.

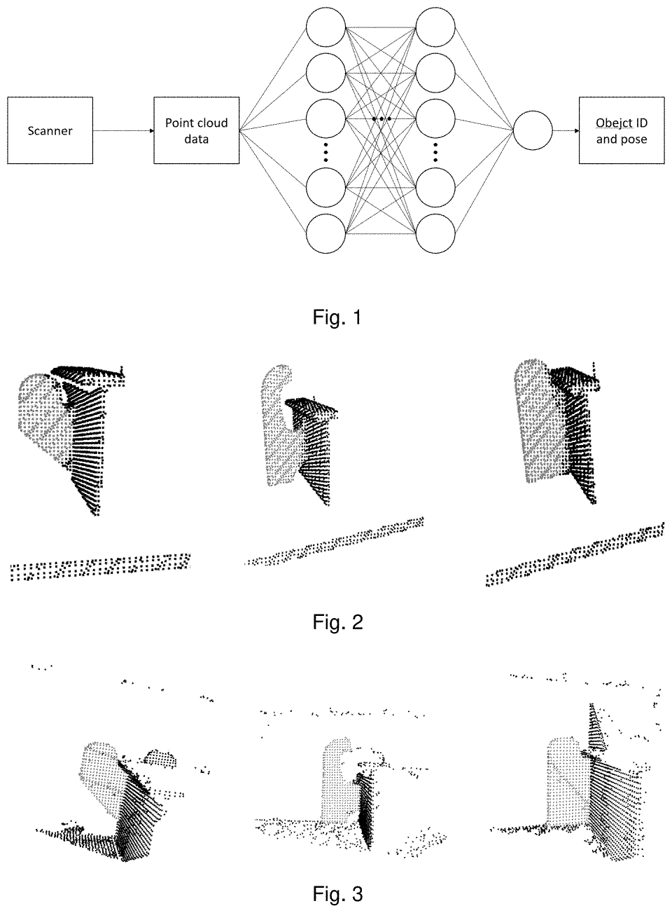

FIG. 1 shows a schematic overview of one embodiment of the presently disclosed approach. Herein a scanner is used to acquire data of the welding environment, the data is then used to generate a 3D point cloud data set which is then fed into an AI approach, in this case in the form of a neural network. The neural network is then used to recognise and detect welding objects in the welding environment. Object pose and location is part of the post processing, and from there it is possible to plan the welding task. Hence, for example the presently disclosed approach be able to determine if a welding environment comprises objects such as profiles, bars, stiffeners, brackets, collar plates, etc. Detection and identification of the type of welding objects and their poses and positions will make it possible to determine the welding path of the associated welding task and the presently disclosed approach is therefore capable of automatically acquiring information necessary to automatically plan a welding task and generate a suitable welding path for a welding robot to execute.

When training the model, e.g. a neural network, both real data and simulated data can advantageously be used. Real data from real physical welding environments may initially be difficult to obtain, whereas simulated training data can more easily be generated. By combining real data with simulated data in the training phase, a sufficient amount of training data can be provided for the training phase. FIG. 2 illustrates three examples of simulated 3D point cloud data used to train a neural network. Here the light gray dots of the three point cloud data sets of FIG. 2 illustrate the part of the welding environment the neural network should recognise as “connecting plate”.

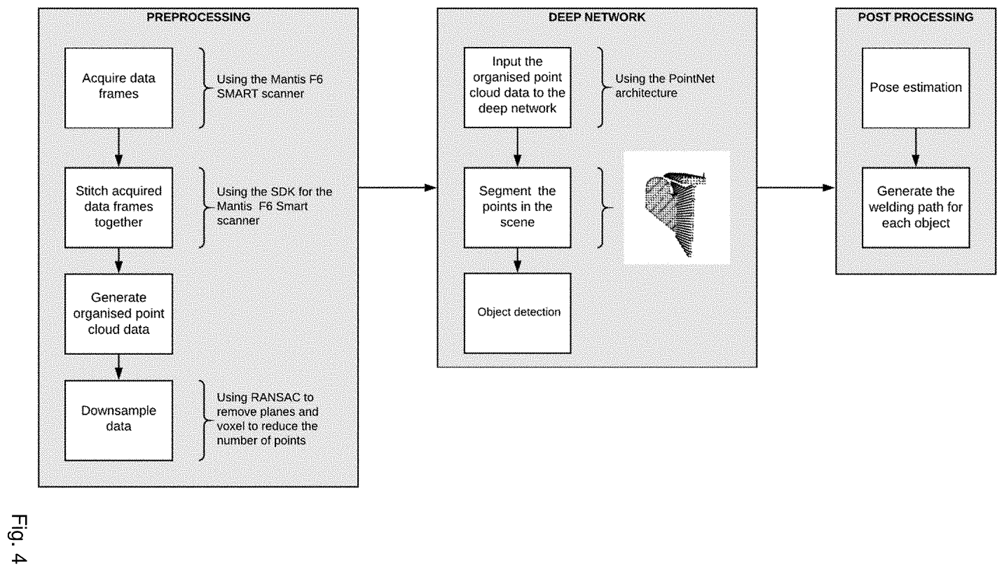

FIG. 3 shows three examples of real training data, e.g. for a neural network. Here the three 3D point cloud data sets are based on three physical objects scanned by a scanner as described in the present disclosure. The light grey points in the three examples of FIG. 3 show the points of the 3D point cloud data which should be identified as “connecting plate” by the neural network.

Another example of the presently disclosed approach is illustrated in FIG. 4, showing a flow chart of the overall process of the presently disclosed approach. Here the first step is pre-processing in which data frames of the welding environment are acquired using a volumetric scanner such as a Mantis F6 scanner. Next, the acquired data frames are stitched together for example by using the Software Development Kit for the Mantis F6 smart scanner. From the stitched together data frames, a point cloud can be generated. Alternatively, a point cloud may be the direct output from a 3D scanner such that pre-procession of the data can be reduced. Subsequently the data may be down-sampled or compressed using random sample consensus (RANSAC) in order to filter out outliner points, for example to remove irrelevant planes and voxels as in this example and hereby reduce the number of points in the dataset.

The compressed point cloud dataset may then be fed into an unsupervised or supervised AI algorithm, e.g. a deep neural network, for example by using the PointNet architecture, which is an example of applying machine learning directly on point clouds.

One advantage of the PointNet approach is that instead of transforming the point cloud data into regular 3D voxel grids or collections of images. This makes it highly efficient and effective and thereby applicable in a real and complex environment as the present welding environment. The present disclosed approach can therefore take point clouds as input to a supervised AI algorithm and the output is labelled for each point of the input, which again can be processed as part of the supervised AI algorithm, such that point labels become semantic object classes such that detection of 3D objects, e.g. welding objects, can be directly provided therefrom. Hence, the AI algorithm can be trained to recognize different objects such as profiles, bars, stiffeners, brackets, collar plates, inserts, cutouts, waterholes, welding seams, plate connections, chamfers, tacks, gaps, plate thickness, bevels or scallops within the welding environment.

The output from the supervised or unsupervised learning algorithm is passed to a post-processing step comprising pose estimation and/or location of each detected welding object in the welding environment object. This makes it possible generate a welding path for each object which can be executed by a welding system.

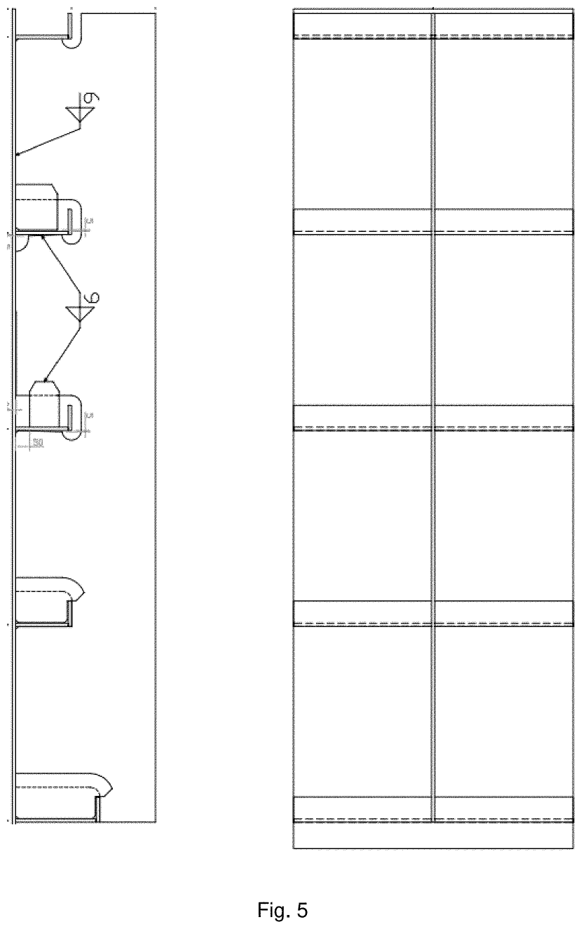

FIG. 5 shows an example of 2D sketch of a test panel wherein four different collar plates are to be welded to the test panel, i.e. the test panel is the welding environment and the different collar plates are the welding objects. The figure to the left in FIG. 5 shows the test panel from the side and the figure to the right shows the test panel from above. Prior to welding the welding system does not know the type of the individual collar plate and where the collar plates are located. The width of the test panel is 10 m, the height of the test panel is 5 m and the length of the test panel is 30 m. The height of the collar plates are approx. 2 m.

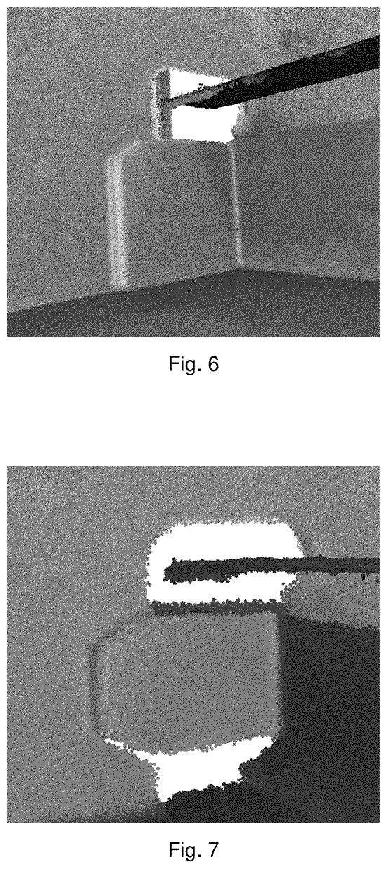

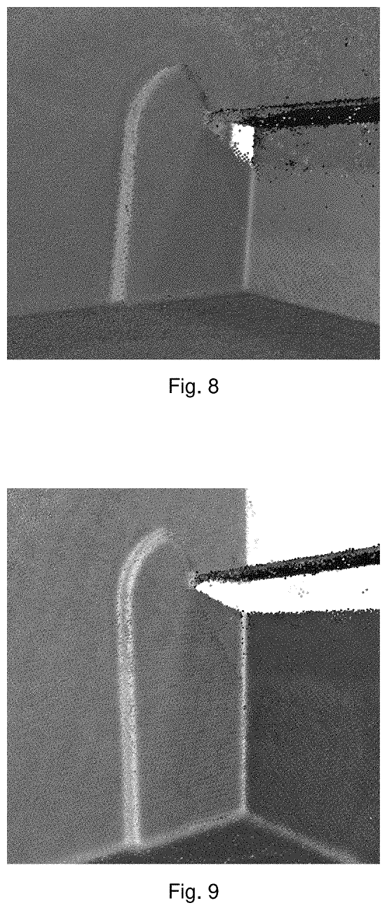

FIGS. 6-9 shows 3D scans of the four different collar plates. This data is real data and 3D point clouds can be generated therefrom. Real scanning data of the test panel can also be generated. Simulated data can then be generated by combining these real data with virtual data, e.g. the real data of the different collar plates can be inserted in a model of the test panel but also in different (irrelevant) background scenes to improve the detection and identification capabilities of the machine learning algorithm. Similarly point clouds can be generated from CAD data of the different collar plates and these data can be inserted in real scanning data acquire from the test panel.

The present disclosure further relates to a welding system comprising a welding machine used to weld material together in an automatic or semi-automatic manner. A robotic or similar automated motion generating mechanism (hereafter referred to as a robot) moves the welding gun of the welding machine while welding the material. The welding machine and the robot are controlled by a robot controller. A scanner may also be part of the welding system, e.g. a 2D scanner or a 3D scanner. A welding path generated by the presently disclosed method can preferably be executed by the presently disclosed welding system. However, the presently disclosed method may also be an integral part of the presently disclosed welding system such that the welding system autonomously can detect, plan and execute welding tasks in a complex environment.

The present disclosure further relates to a system for automatic detection and/or planning of a welding task in a welding environment, comprising a non-transitive, computer-readable storage device for storing instructions that, when executed by a processor, performs a method for automatic detection and/or planning of a welding task in a welding environment according to the described method. The system may comprise a computing device comprising a processor and a memory and being adapted to perform the method, but it can also by a stationary system or a system operating from a centralized location, and/or a remote system, involving e.g. cloud computing. In this case the actual processing, in particular the detection of welding objects based on AI, may be provided by cloud computing.

The present disclosure further relates to a computer program having instructions which when executed by a computing device or system cause the computing device or system to automatically detect and/or plan a welding task in a welding environment according to the described method. Computer program in this context shall be construed broadly and include e.g. programs to be run on a PC or software designed to run on welding systems, smartphones, tablet computers or other mobile devices. Computer programs and mobile applications include software that is free and software that has to be bought, and also include software that is distributed over distribution software platforms.

### REFERENCES

[1] Qi et al.: “PointNet: Deep Learning on Point Sets for 3D Classification and Segmentation”, published on arXiv.org in April 2017
[2] Qi al.: “PointNet++: Deep Hierarchical Feature Learning on Point Sets in a Metric Space”, published on arXiv.org in June 2017

1. A computer implemented method for automatic detection and/or planning of a welding task in a welding environment, the method comprising the steps of:
obtaining scanning data from a scan of the welding environment;
automatically detecting welding object(s) in the scanning data, and identifying the type of the welding object(s) by means of artificial intelligence employing a machine learning algorithm, wherein the machine learning algorithm has been trained on real and simulated 3D data of known welding objects; and
determining the pose of each detected welding object.

2. The method according to claim 1, wherein a supervised learning algorithm is used to detect and identify the welding object(s).

3. The method according to claim 1, wherein an unsupervised learning algorithm is used to detect and identify the welding object(s).

4. The method according to claim 1, wherein the machine learning is selected from the group of: deep learning, nearest neighbour, naive Bayes, decision trees, linear regression, support vector machines (SVM) and neural networks.

5. The method according to claim 1, wherein the known welding objects are selected from the group of: profiles, bars, stiffeners, brackets, collar plates, inserts, cutouts, waterholes, welding seams, plate connections, chamfers, tacks, gaps, plate thickness, bevels and scallops.

6. The method according to claim 1, further comprising the step of generating an unordered point cloud from the scanning data obtained from the scan of the welding environment and utilizing the point cloud directly as input to the machine learning algorithm.

7. The method according to claim 1, wherein the machine learning algorithm is configured for semantic segmentation of the scanning data such that each pixel/voxel in the scanning data is classified from a predefined set of classes and wherein the detection of the welding objects is provided by means of the semantic segmentation.

8. The method according to claim 7, wherein the predefined set of classes comprise the following 3D objects: profiles, bars, stiffeners, brackets, collar plates, inserts, cutouts, waterholes, welding seams, plate connections, chamfers, tacks, gaps, plate thickness, bevels, scallops.

9. The method according to claim 1, wherein the obtained scanning data is 2D data.

10. The method according to claim 1, wherein the obtained scanning data is 3D data.

11. The method according to claim 1, wherein the scanning data obtained from the scan of the welding environment is in the form of frame data and wherein stitched scene-data from individual frames of the frame data are generated.

12. The method according to claim 11, wherein data points of the stitched scene-data from the individual frames are down-sampled or compressed before generation of a point cloud.

13. The method according to claim 11, wherein outlying data points of the stitched scene-data from the individual frames are removed prior to generation of a point cloud, such as by means of random sample consensus.

14. A system for automatic detection and/or planning of a welding task in a welding environment, comprising a non-transitive, computer-readable storage device for storing instructions that, when executed by a processor, performs a method for automatic detection and/or planning of a welding task in a welding environment according to claim 1.

15. A robotic welding system for operating in a welding environment, comprising:
a welding machine comprising at least one welding gun for welding material together in an automatic or semi-automatic manner;
an automated motion generating mechanism for moving the welding gun of the welding machine while welding the material;
a scanner for scanning at least part of the welding environment to generate scanning data; and
a processing unit configured for executing the method according to claim 1 based on scanning data from the scanner thereby generating a welding path, wherein the robotic welding system is configured to execute the welding path.

16. The method according to claim 1, further comprising the step of generating a welding path for each detected welding object
